(19) United States
(12) Patent Application Publication
(10) Pub. No.: US 2015/0120386 A1
(43) Pub. Date: Apr. 30, 2015

(54) SYSTEM AND METHOD FOR IDENTIFYING PURCHASE INTENT

(71) Applicants: Corinne Elizabeth Sherman, San Jose, CA (US); Don Watters, Newcastle, WA (US); Chandan Golla, Redmond, WA (US)

(72) Inventors: Corinne Elizabeth Sherman, San Jose, CA (US); Don Watters, Newcastle, WA (US); Chandan Golla, Redmond, WA (US)

(21) Appl. No.: 14/338,593

(22) Filed: Jul. 23, 2014

Related U.S. Application Data
(60) Provisional application No. 61/896,534, filed on Oct. 28, 2013.

(51) Int. Cl. G06Q 30/02; G06Q 50/00

(52) U.S. Cl. CPC G06Q 30/0202; G06Q 50/01
USPC 705/7.31

(57) ABSTRACT

A system comprising a computer-readable storage medium storing at least one program, and a computer-implemented method for determining and scoring purchase intent of users, are described herein. Consistent with some embodiments, the method may include obtaining social data of a plurality of users from one or more social network services. The social data is analyzed to identify users with intent to purchase products. The identified users may then be scored according to the level of intent of each user to purchase the products. The method may further include communicating a message to a merchant to notify the merchant of the intent of the identified users to purchase the products.

### PRIORITY

This patent application claims the benefit of priority, to U.S. Provisional Patent Application Ser. No. 61/896,534, filed Oct. 28, 2013, which is incorporated herein by reference in its entirety.

### TECHNICAL FIELD

This application relates to data processing. In particular, example embodiments relate to systems and methods for determining purchase intent of a user.

### BACKGROUND

Merchants often face difficulty finding buyers for the products that they are selling. Further, merchants may often be unaware of market demand for certain products, and as a result, a merchants' inventory may not be in accordance with actual demand (e.g., the merchants have either too few or too many items). Consumers, on the other hand, regularly use social networking services to connect with other people over the Internet, and in doing so, share many personal details that provide insights into a person's needs, wants, and future behavior.

### BRIEF DESCRIPTION OF THE DRAWINGS

Various ones of the appended drawings merely illustrate example embodiments of the present inventive subject matter and cannot be considered as limiting its scope.

FIG. 1 is a network diagram depicting a network system having a client-server architecture configured for exchanging data over a network, according to an example embodiment.

FIG. 2 is a block diagram illustrating an example embodiment of multiple modules forming the marketplace applications of FIG. 1, according to an example embodiment.

FIG. 3 is a block diagram illustrating an example embodiment of multiple modules forming a purchase intent application, which is provided as part of the network system of FIG. 1.

FIG. 4 is a screen diagram illustrating an example social network activity feed with example social network entries, consistent with some embodiments.

FIG. 5 is a flowchart illustrating an example method for connecting buyers and sellers by scanning social information, consistent with some embodiments.

FIG. 6 is a flowchart illustrating an example method for determining a purchase intent score, consistent with some embodiments.

FIG. 7 is a flowchart illustrating an example method for identifying a product based on product information included in a social network entry, consistent with some embodiments.

FIG. 8 is a diagrammatic representation of a machine in the example form of a computer system within which a set of instructions for causing the machine to perform any one or more of the methodologies discussed herein may be executed.

### DETAILED DESCRIPTION

Reference will now be made in detail to specific example embodiments for carrying out the inventive subject matter. Examples of these specific embodiments are illustrated in the accompanying drawings. It will be understood that they are not intended to limit the scope of the claims to the described embodiments. On the contrary, they are intended to cover alternatives, modifications, and equivalents as may be included within the scope of the disclosure as defined by the appended claims. In the following description, specific details are set forth in order to provide a thorough understanding of the subject matter. Embodiments may be practiced without some or all of these specific details.

Aspects of the present disclosure describe systems and methods for determining and scoring purchase intent of a user. Consistent with some embodiments, the method may include obtaining social data from one or more social network services (e.g., Facebook®, Twitter®, Google+®, Pinterest®, Svpply®). The social data may be analyzed to identify users with intent to purchase products offered for sale by online merchants. The identified users may then be scored according to a level of intent of each user to purchase the products. In some embodiments, market demand information may also be generated based on an analysis of the social data. The method may further include notifying merchants of the intent of the users to purchase the products. Such notifications may also include the score of each user and the market demand information.

Consistent with some embodiments, the notifications of users' purchase intent may also include helpful recommendations based on the social network activity data related to the products sold by the merchants. For example, merchants offering products that are trending (according to the social network activity) may be provided a recommendation to increase their stock of the trending products. In some embodiments, the system may notify the users identified as having the intent to purchase a product (e.g., potential buyers) of listings for the products they wish to purchase, and such notifications may also facilitate the purchase of these products.

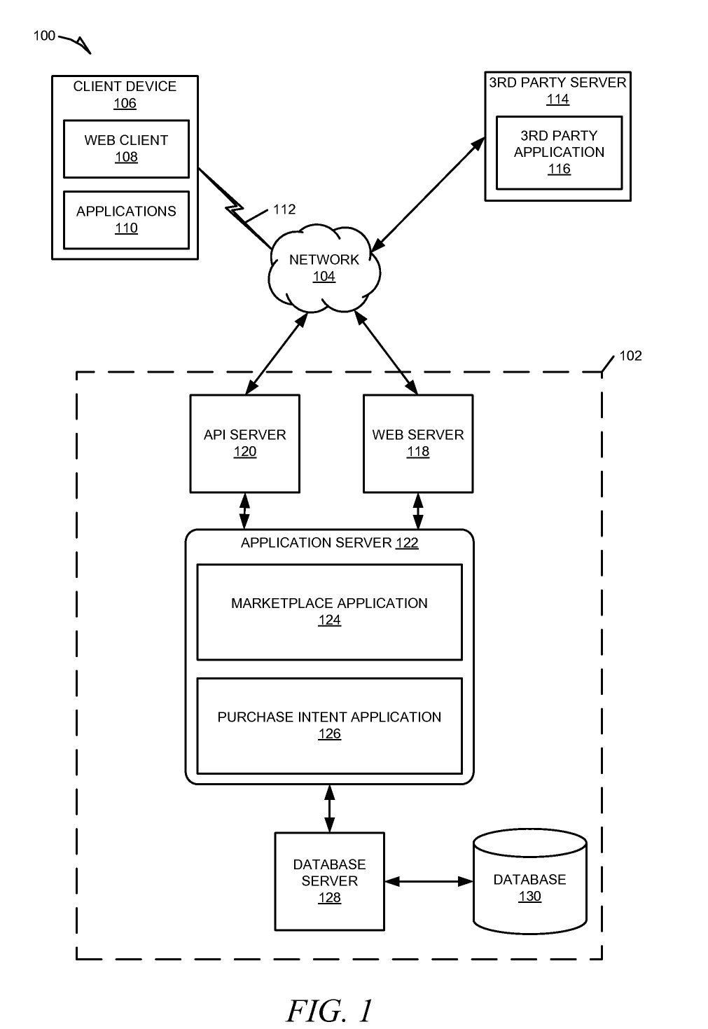

FIG. 1 is a network diagram depicting a network system 100, according to one embodiment, having a client-server architecture configured for exchanging data over a network. The network system 100 may include a network-based content publisher 102 in communication with a client device 106 and a third party server 114. In some example embodiments, the network-based content publisher 102 may be a network-based marketplace.

The network-based content publisher 102 may communicate and exchange data within the network system 100 that may pertain to various functions and aspects associated with the network system 100 and its users. The network-based content publisher 102 may provide server-side functionality, via a network 104 (e.g., the Internet), to client devices such as, for example, the client device 106. The client device 106 may be operated by a user who uses the network system 100 to exchange data over the network 104. These data exchanges may include transmitting, receiving (e.g., communicating), and processing data to, from, and regarding content and users of the network system 100. The data may include, but are not limited to: images; video or audio content; user preferences; product and service feedback, advice, and reviews; product, service, manufacturer, and vendor recommendations and identifiers; product and service listings associated with buyers and sellers; product and service advertisements; auction bids; transaction data; user profile data; and social data, among other things.

In various embodiments, the data exchanged within the network system 100 may be dependent upon user-selected functions available through one or more client or user interfaces (UIs). The UIs may be associated with a client device, such as the client device 106 executing a web client 108 (e.g., a browser application that displays content, such as a web page). The web client 108 may be in communication with the network-based content publisher 102 via a web server 118. The UIs may also be associated with one or more applications 110 executing on the client device 106, such as a client application designed for interacting with the network-based content publisher 102, or the UIs may be associated with the third party server 114 (e.g., one or more servers or client devices) hosting a third party application 116. An example of the applications 110 is a mobile marketplace application that is used to interact with an online marketplace that may be provided by the network-based content publisher 102. Another example of the applications 110 are social networking applications (e.g., Facebook®, Twitter®, Google+®, Pinterest®, Svpply®) that may be used to interact with social network services (e.g., hosted by the third party server 114).

The client device 106 may interface via a connection 112 with the network 104 (e.g., the Internet or a wide area network (WAN)). Depending on the form of the client device 106, any of a variety of types of connection 112 and network 104 may be used. For example, the connection 112 may be a Code Division Multiple Access (CDMA) connection, a Global System for Mobile communications (GSM) connection, or other type of cellular connection. Such a connection 112 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, or other data transfer technology (e.g., fourth generation wireless, 4G networks). When such technology is employed, the network 104 may include a cellular network that has a plurality of cell sites of overlapping geographic coverage, interconnected by cellular telephone exchanges. These cellular telephone exchanges may be coupled to a network backbone (e.g., the public switched telephone network (PSTN), a packet-switched data network, or other types of networks).

In another example, the connection 112 may be Wireless Fidelity (Wi-Fi, IEEE 802.11x type) connection, a Worldwide Interoperability for Microwave Access (WiMAX) connection, or another type of wireless data connection. In such an embodiment, the network 104 may include one or more wireless access points coupled to a local area network (LAN), a WAN, the Internet, or other packet-switched data network. In yet another example, the connection 112 may be a wired connection, for example an Ethernet link, and the network 104 may be a LAN, a WAN, the Internet, or other packet-switched data network. Accordingly, a variety of different configurations are expressly contemplated.

FIG. 1 also illustrates the third party application 116 executing on the third party server 114 that may offer one or more services to users of the client device 106. The third party application 116 may have programmatic access to the network-based content publisher 102 via a programmatic interface provided by an application program interface (API) server 120. In some embodiments, the third party application 116 may be associated with any organization that may conduct transactions with or provide services to the users of the client device 106. For example, the third party application 116 may be associated with a network based social network service (e.g., Facebook®, Twitter®, Google+®, Pinterest®, LinkedIn®) that may provide a platform for members to build and maintain social networks and relations among other members.

Turning specifically to the network-based content publisher 102, the API server 120 and the web server 118 are coupled to, and provide programmatic and web interfaces respectively to, an application server 122. As illustrated in FIG. 1, the application server 122 may be coupled via the API server 120 and the web server 118 to the network 104, for example, via wired or wireless interfaces. The application server 122 is, in turn, shown to be coupled to a database server 128 that facilitates access to a database 130. In some examples, the application server 122 can access the database 130 directly without the need for the database server 128. The database 130 may include multiple databases that may be internal or external to the network-based content publisher 102.

The application server 122 may, for example, host one or more applications, which may provide a number of content publishing and viewing functions to users who access the network-based content publisher 102. For example, the application server 122 may host a marketplace application 124 that provides a number of marketplace functions and services to users, such as publishing, listing, and price-setting mechanisms whereby a seller may list (or publish information concerning) goods or services (collectively referred to as “products”) for sale, a buyer can express interest in, or indicate a desire to purchase, such goods or services, and a price can be set for a transaction pertaining to the goods or services. The application server 122 may also host a purchase intent application 126 that may be configured to analyze social network activity to determine purchase intent of users.

The database 130 may store data pertaining to various functions and aspects associated with the network system 100 and its users. For example, user profiles for users of the network-based content publisher 102 may be stored and maintained in the database 130. Each user profile may comprise user data that describes aspects of a particular user. The user data may, for example, include demographic data, user preferences, social data, and financial information. The demographic data may, for example, include information describing one or more characteristics of a user such as gender, age, location information (e.g., hometown or current location), employment history, education history, contact information, familial relations, or user interests. The financial information may, for example, include private financial information of the user such as account number, credential, password, device identifier, user name, phone number, credit card information, bank information, transaction history or other financial information which may be used to facilitate online transactions by the user. Consistent with some embodiments, the transaction history may include information related to transactions for items or services (collectively referred to as “products”) that may be offered for sale by merchants using marketplace services provided by the network-based content publisher 102. The transaction history information may, for example, include a description of a product offered for sale, sold, or purchased by the user, an identifier of the product, a category to which the product belongs, a purchase price, a quantity, a number of bids for the product, or various combinations thereof.

The user data may also include a record of user activity, consistent with some embodiments. Accordingly, the network-based content publisher 102 may monitor, track, and record the activities and interactions of a user, using one or more devices (e.g., client device 106), with the various modules of the network system 100. Each user session may be stored in the database 130 and maintained as part of the user data. Accordingly, in some embodiments, the user data may include a record of past keyword searches that users have performed, a browsing history (e.g., web pages viewed by each user), products added to a user wish list or watch list, products added to an electronic shopping cart, and products that the users own. User preferences may be inferred from the user activity.

While the purchase intent application 126 is shown in FIG. 1 to form part of the network-based content publisher 102, it will be appreciated that, in alternative embodiments, the purchase intent application 126 may form part of a service that is separate and distinct from the network-based content publisher 102. Further, while the network system 100 shown in FIG. 1 employs client-server architecture, the present inventive subject matter is, of course, not limited to such an architecture, and could equally well find application in an event-driven, distributed, or peer-to-peer architecture system, for example. The various functional components of the application server 122 may also be implemented as standalone systems or software programs, which do not necessarily have networking capabilities. It shall be appreciated that although the various functional components of the network system 100 are discussed in the singular sense, multiple instances of one or more of the various functional components may be employed.

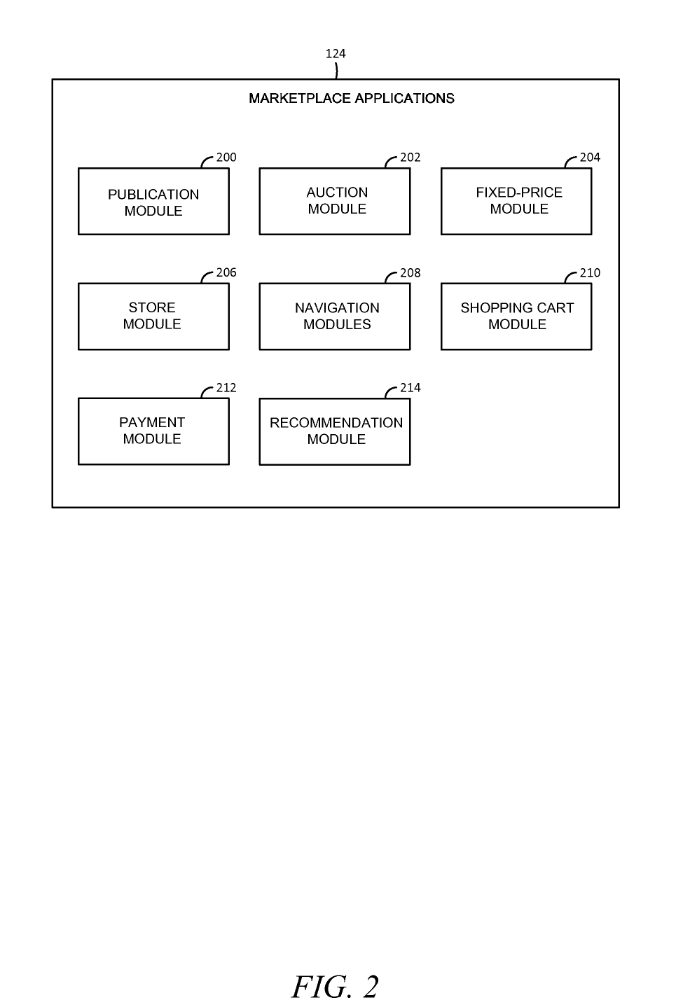

FIG. 2 is a block diagram illustrating an example embodiment of multiple modules forming the marketplace application 124 of FIG. 1, according to an example embodiment. The modules of the marketplace application 124 may be hosted on dedicated or shared server machines that are communicatively coupled to enable communications between server machines. Each of the modules 200-214 is communicatively coupled (e.g., via appropriate interfaces) to the other modules and to various data sources, so as to allow information to be passed among the modules 200-214 of the marketplace application 124 or so as to allow the modules 200-214 to share and access common data. The various modules of the marketplace application 124 may, furthermore, access one or more of the databases 130 via the database servers 128.

The marketplace application 124 may provide a number of publishing, listing, and price-setting mechanisms whereby a seller may list (or publish information concerning) goods or services for sale, a buyer can express interest in or indicate a desire to purchase such goods or services, and a price can be set for a transaction pertaining to the goods or services. To this end, the marketplace application 124 is shown to include at least one publication module 200 and one or more auction modules 202, which support auction-format listing and price setting mechanisms (e.g., English, Dutch, Vickrey, Chinese, Double, Reverse auctions). The various auction modules 202 may also provide a number of features in support of such auction-format listings, such as a reserve price feature whereby a seller may specify a reserve price in connection with a listing, and a proxy-bidding feature whereby a bidder may invoke automated proxy bidding.

A fixed-price module 204 supports fixed-price listing formats (e.g., the traditional classified-advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with auction-format listings, and allow a buyer to purchase goods or services, which are also being offered for sale via an auction, for a fixed price that is typically higher than the starting price of the auction.

A store module 206 allows sellers to group their product listings (e.g., goods and/or services) within a “virtual” store, which may be branded and otherwise personalized by and for the sellers. Such a virtual store may also offer promotions, incentives, and features that are specific and personalized to a relevant seller. In one embodiment, the listings or transactions associated with the virtual store and its features may be provided to one or more users.

Navigation of the network-based content publisher 102 may be facilitated by one or more navigation modules 208. For example, a search module may, inter alia, enable key word searches of listings published via the network-based content publisher 102. A browser module may allow users via an associated UI to browse various category, catalogue, inventory, social network, and review data structures within the network-based content publisher 102. Various other navigation modules 208 (e.g., an external search engine) may be provided to supplement the search and browser modules. Consistent with some embodiments, the results for key word searches of listings published via the network-based content publisher 102 may be filtered to include only listings corresponding to social network connections of the user (e.g., indicated friends and family).

A shopping cart module 210 is used to create an electronic shopping cart used by users of the network-based content publisher 102 to add and store products (e.g., goods and services) listed by the store modules 206. The shopping cart modules 210 may also be used to “check out,” meaning a user may purchase products in the electronic shopping cart. The shopping cart modules 210 may facilitate the transactions by automatically finding the products in the electronic shopping cart across at least one or all of a predefined set of vendors, a comparison shopping site, an auction site, etc. In various embodiments, the selection criteria for which vendor or vendors to purchase from may include, but are not limited to, criteria such as lowest cost, fastest shipping time, preferred or highest rated vendors or sellers, or any combination thereof.

A payment module 212 may provide a number of payment services and functions to users. The payment module 212 may allow users to accumulate value (e.g., in a commercial currency, such as the U.S. dollar, or a proprietary currency, such as “points”) in accounts, and then later to redeem the accumulated value for products (e.g., goods or services) that are made available via the marketplace applications 124. For some example embodiments, the payment module 212 generally enables transfer of values (e.g., funds, reward points) from an account associated with one party (e.g., a sender) to another account associated with another party (e.g., a receiver).

A recommendation module 214 may provide recommendation services and functions to users. In some embodiments, the recommendation module 214 receives requests for recommendations, and, in turn, provides a recommendation to the user based on information contained in the user's corresponding user profile. In some embodiments, the recommendation module 214 may automatically generate and provide a recommendation based on the activity of the user. The recommendations provided by the recommendation modules 214 may contain one or more items (e.g., products offered for sale, articles, blogs, movies, social network connections) that may potentially interest a user. The recommendations may, for example, be based on previous products purchased by the user or a social network connection of the user, a web page viewed by the user, or an item given favorable feedback by the user or a social connection of the user.

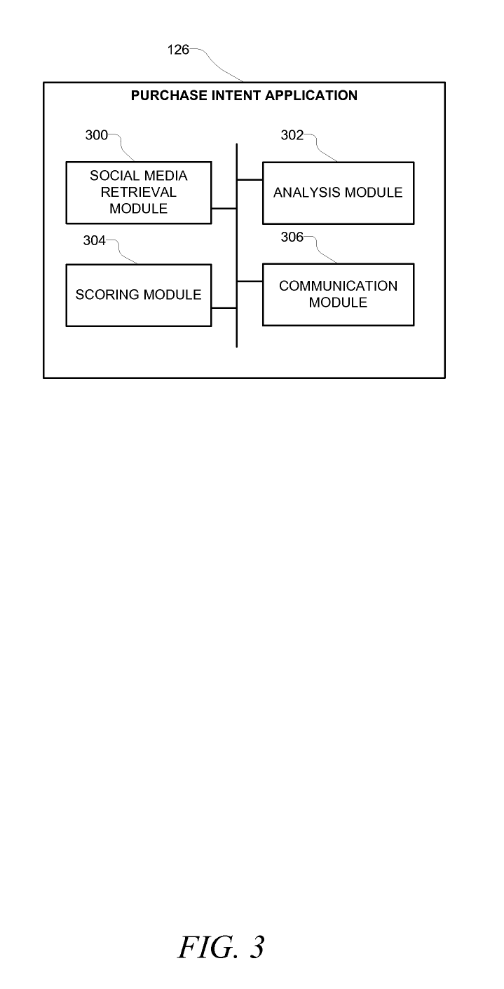

FIG. 3 is a block diagram illustrating an example embodiment of multiple modules forming the purchase intent application 126, which is provided as part of the network-based content publisher 102. The purchase intent application 126 is shown as including a social media retrieval module 300, an analysis module 302, a scoring module 304, and a communication module 306, all configured to communicate with each other (e.g., via a bus, shared memory, a switch, or application programming interfaces (APIs)). The various modules of the purchase intent application 126 may, furthermore, access one or more databases 130 via the database servers 128, and each of the various modules of the purchase intent application 126 may be in communication with one or more of the third party applications 116.

The social media retrieval module 300 may be configured to retrieve and record social data from social network services. The term “social data” refers to information maintained by the social network service about its members. The social data of each member may contain information such as demographic information (e.g., gender, age, relationship status, employment status and history, household size), geographic information (e.g., a hometown, a current location, locations visited), interests and affinities (e.g., items the member “liked”), a list of social network connections, and a history of social network activity of the user.

For purposes of the present disclosure, a social network “connection” (also referred to as being “connected” on a social network) may include situations in which there is a reciprocal agreement between members of the social network to be linked on the social network, as well as situations in which there is only a singular acknowledgement of the “connection” without further action being taken by the other member. In the reciprocal agreement situation, both members of the “connection” acknowledge the establishment of the connection (e.g., friends). Similarly, in the singular acknowledgement situation, a member may elect to “follow” or “watch” another member. In contrast to a reciprocal agreement, the concept of “following” another member typically is a unilateral operation because it may not call for acknowledgement or approval by the member who is being followed.

For purposes of the present disclosure, “social network activity” collectively refers to user interactions (e.g., creating, sharing, viewing, commenting on, providing feedback, or expressing interest) with entries (e.g., text and image posts, links, messages, notes, invitations). Such social network activity may involve entries that are intended for the public at large as well as entries intended for a particular social network connection or group of social network connections. Depending on the social network service, the social network activity may be published in an entry and may involve entries such as an activity feed post, a wall post, a status update, a tweet, a pin, a like, a content share (e.g., content shared from a source such as the network-based content publisher 102), or a check-in.

For purposes of the present disclosure, a “check-in” refers to a service provided by a social network that allows users to check in to a physical space or virtual space and share their location with other users of the social network. Consistent with some embodiments, users may check in to a specific location by using a mobile application provided by the social network on a client device (e.g., client device 106). For example, a social network mobile application may use the GPS functionality of the client device to find a current location of the user and allow the user to share this information with other users of the social network.

The social media retrieval module 300 may obtain social data via publically accessible APIs provided by the social network services. In some embodiments, the social media retrieval module 300 may obtain social data of users of the network-based content publisher 102, and maintain the social data as part of the user data comprising each of the respective user's profiles, which are stored in the databases 130. The social media retrieval module 300 may also obtain social data of social network connections of users of the network-based content publisher 102, and maintain such data as part of the user data of each user.

The analysis module 302 may be configured to analyze the social data obtained by the social media retrieval module 300 to identify users with intent to purchase products (e.g., items or services). As part of this process, the analysis module 302 may analyze social network entries included in the social data to identify certain words or phrases (hereinafter referred to as “purchase intent terms”) from the entries that are indicative of a potential intent (or desire) of a user to purchase a product. For example, a social network entry stating, “I want to buy the new Xbox One!!” would be indicative of the user's intent (or desire) to purchase a new Xbox One. A particular user whose social network entry is identified as having one or more purchase intent terms may be identified (e.g. by the analysis modules 302) as a user with intent to purchase a product (also referred to herein as “purchase intent”). This information may be maintained as part of the user data comprising the particular user's user profile.

In some embodiments, the identification of the purchase intent terms performed by the analysis module 302 may comprise performing natural language processing for each entry to mine words and phrases from each entry that are indicative of the intent to purchase a product. In turn, the words and phrases extracted from these entries may be compared to a database of known words or phrases that are indicative of purchase intent.

The analysis module 302 may also identify product information from the social network entries that is referenced in conjunction with the purchase intent terms. The product information identified by the analysis module 302 may include a product identifier (e.g., product name, model or serial number, or other numerical identifier) that identifies the product that is the subject of the purchase intent of the user. The product information may be identified using natural language processing. In some instances, a particular social network entry that has been identified as having purchase intent terms may also include one or more images. In these instances, the identification of the product information may include performing image recognition on the one or more images to identify products from the images. The analysis module 302 uses the product information (e.g., identified by language processing or image recognition) to locate identical or similar products from a product database or catalog (e.g., database 130). In some instances, the identified products may have a corresponding electronic marketplace listing (e.g., hosted by the network-based content publisher 102) offering the product for sale.

The analysis module 302 may be further configured to generate market demand information for a product, group of products (e.g., a product bundle), or category of products. The analysis module 302 may generate market demand information based on the number of users identified as having a purchase intent directed to a particular product, group of products, or category of products. The market demand information may include a quantity of a particular product demanded by users at the current listed price. The market demand information may also include a quantity of a particular product demanded by users at other prices.

The analysis module 302 may also work in conjunction with the recommendation modules 214 to recommend products to a potential buyer. The recommended products may correspond to a similar product referenced in a social network entry generated by the potential buyer. In some embodiments, the products included in a recommendation may be marketplace listings of social network connections of the potential buyer. In some embodiments, the products included in a recommendation may be based on product trend information (e.g., stored in database 130).

The scoring module 304 may be configured to determine purchase intent scores for users identified as having purchase intent. The purchase intent score provides a measure of the user intent to purchase products. The scoring modules 304 may calculate a purchase intent score according to a user's intent to purchase a particular product or intent to purchase a product from a particular product category. The purchase intent scores determined by the scoring module 304 may be based on an analysis of both user data and social data of users.

The purchase intent score calculated by the scoring module 304 may be based on a combination of factors including, but not limited to, a number of purchase intent terms appearing in a particular social network entry; a number of times the user has referenced a particular product in one or more social network entries; a number of social network entries of the user identified as having one or more purchase intent terms; an intensity of the purchase intent terms used; a number of products purchased by the user relative to the number of social network entries identified as having one or more purchase intent terms; a number of times the user has used a particular set of keywords in performing a query for products offered for sale on a network-based marketplace; a product added to an electronic shopping cart of the user; and a number of page views by the user for a particular product offered for sale on a network-based marketplace.

The communication module 306 may be configured to facilitate communications between users of the network system 100. For example, the communication module 306 may be used for generation and delivery of messages to users of the network-based content publisher 102. The communication module 306 may also be used for generation and delivery of messages to merchants utilizing services provided by the network-based content publisher 102.

The communication module 306 may utilize any one of a number of message delivery networks and platforms to deliver messages to users. For example, the communication modules 306 may deliver electronic mail (e-mail), instant message (IM), Short Message Service (SMS), text, facsimile, or voice (e.g., Voice over IP (VoIP)) messages via the wired (e.g., the Internet), plain old telephone service (POTS), or wireless (e.g., mobile, cellular, WiFi, WiMAX) networks. The communication modules 306 may also be used to generate social network entries to be posted to social networks on behalf of a user or to be communicated directly to the user. The social network entries may include one or more hyperlinks that may automatically redirect a user's browser to a particular marketplace listing (e.g., generated using the marketplace application 124).

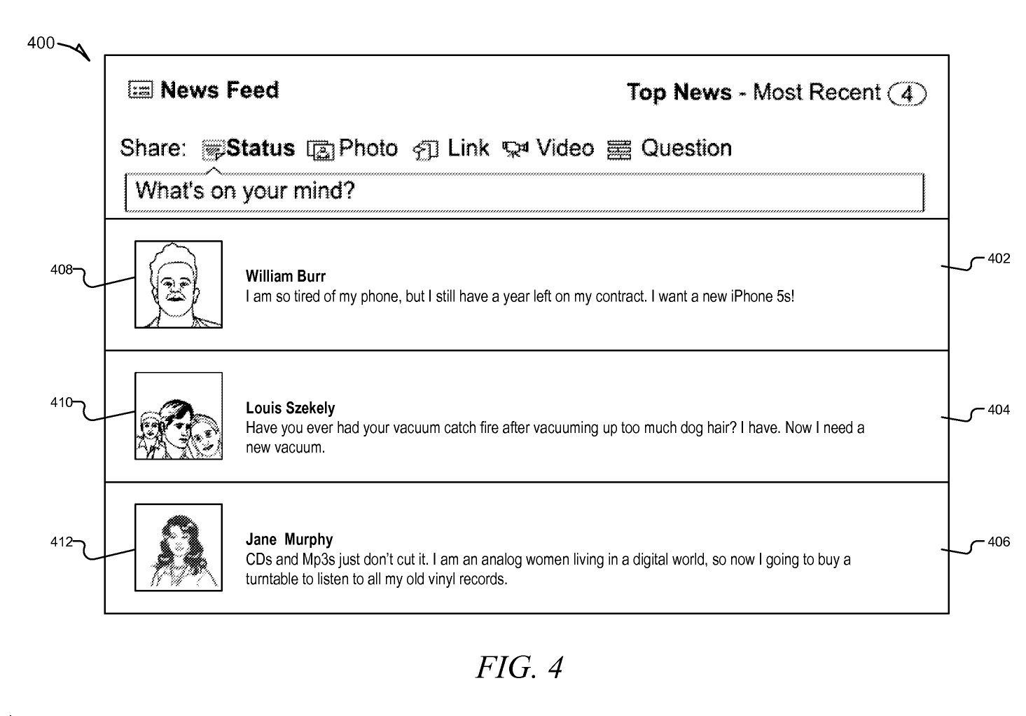

FIG. 4 is a screen diagram illustrating an example social network activity feed 400 including example social network entries 402, 404, and 406, consistent with some embodiments. As shown in FIG. 4, the activity feed 400 includes social network entries 402, 404, and 406 posted by users 408, 410, and 412, respectively. As shown, the user 408 specifically posts, in entry 402, the intent to purchase a new iPhone. Similarly, the user 410 specifically posts, in entry 404, the need to purchase a new vacuum. Likewise, the user 412 specifically posts, in entry 406, the intent to purchase a new turntable.

In example embodiments, the social media retrieval module 300 may retrieve social data representing the entries 402, 404, and 406 for analysis by the analysis module 302. In turn, the analysis module 302 may identify the purchase intent terms “want,” “need,” and “buy” from the entries 402, 404, and 406, respectively. Further, through processing of the words “want a new iPhone 5s,” “need a new vacuum,” and “buy a turntable,” the analysis module 302 may identify each of the users 408, 410, and 412 as potential buyers having the intent to purchase an iPhone 5s, a vacuum, and a turntable, respectively.

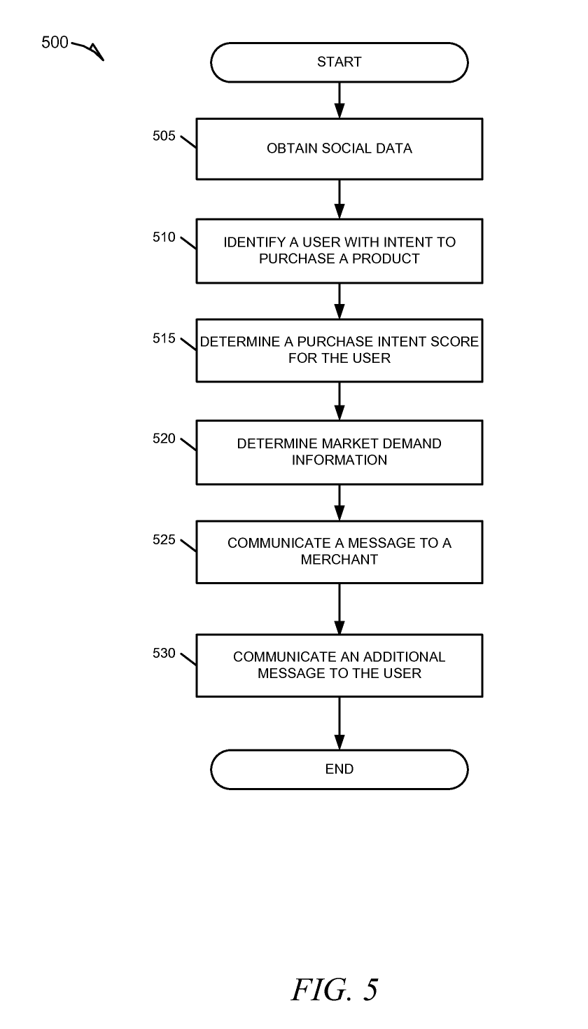

FIG. 5 is a flowchart illustrating an example method 500 for connecting buyers and sellers by scanning social information, consistent with some embodiments. The method 500 may be embodied in computer-readable instructions for execution by one or more processors such that the steps of the method 500 may be performed in part or in whole by the application server 122. In particular, the method 500 may be carried out by the modules forming the purchase intent application 126, and accordingly, the method 500 is described below by way of example with reference thereto. However, it shall be appreciated that the method 500 may be deployed on various other hardware configurations and is not intended to be limited to the modules of the purchase intent application 126.

As shown in FIG. 5, at operation 505, the social media retrieval modules 300 may obtain social data of a plurality of users from one or more social network services. The social data retrieved by the social media retrieval module 300 may include social network activity that is publicly accessible and available to be scanned by the social media retrieval module 300. Alternatively, a user of the network-based content publisher 102 may grant the network-based content publisher 102 permission to access their social networking sites to learn more about the user. In addition, the social data obtained by social media retrieval modules 300 may include the social network activity of each user's social network connections.

At operation 510, the analysis module 302 identifies a user from the plurality of users with intent to purchase a product. The identification of the user with purchase intent may comprise identifying purchase intent terms from a social network entry (e.g., included in the social data) of the user. Such social network entries may identify a product, and the purchase intent terms may indicate an intent to buy the product. In some embodiments, the identification of the user with purchase intent comprises accessing key word searches (e.g., keyword searches enabled by the navigation modules 208, and stored as user data) performed by the user for listings published via the marketplace application 124.

At operation 515, the scoring module 304 determines a purchase intent score for the identified user based on the purchase intent exhibited by the user. The purchase intent score indicates a user's level of intent to purchase a particular product or a product from a particular category of products. As part of the purchase intent score determination, the scoring module 304 may analyze the social network activity included in the social data of the user to determine the level of purchase intent exhibited by the user. The scoring module 304 may, for example, determine the level of purchase intent based on the number of purchase intent terms used in a social network entry, the intensity of purchase intent terms used, the number of times a particular product is referenced, or a frequency with which a particular product is referenced. In some embodiments, the scoring module 304 may also analyze user data of the user to determine the level of purchase intent. For example, the purchase intent score of the user may be based on products purchased by the user, keyword searches performed by the user, products added to an electronic shopping cart of the user, or product listings viewed by the user.

The method 500 may optionally include determining market demand information at operation 520. The market demand information may include a quantity of products demanded by the plurality of users at the current price as well as at other price points. The analysis modules 302 may generate the market demand information based on an analysis of the social data obtained at operation 505. For example, the analysis modules 302 may generate the market demand information based on a number of other users identified from the obtained social data as having the intent to purchase a particular product, a category of products, or group of products.

At operation 525, the communication module 306 communicates a message to a merchant who offers the product that is the object of the purchase intent of the identified user. The message may include a list of users with purchase intent, and the respective purchase intent score of each user. The users may be presented as an ordered list, the order of which corresponds to the respective purchase intent of each user included in the list. In this manner, merchants may be provided with insight into their respective markets, and merchants may use this information to more directly target users who are interested in purchasing products that are offered by the merchant.

The message may also include the market demand information generated at operation 520, and may include suggestions to the merchant. Consistent with some embodiments, the message may be communicated to the merchants automatically in response to the market demand information indicating that the market demand is above a predefined threshold. The suggestions that may be included in the message involve a proposed course of action for the merchant in light of the market demand information. For example, if the market demand information indicates that demand for “purple T-shirts” is very high, then the message may include a suggestion to increase inventory of “purple T-shirts.” In another example, if the market demand information indicates that the demand for a particular model of digital camera is low, the message may include a suggestion to increase advertising for the particular model of digital camera.

The method 500 may optionally include communicating an additional message to the identified user at operation 530 (e.g., by the communication modules 306). The message may identify a marketplace listing (e.g., a product offered for sale using the marketplace application 124) corresponding to the product that the user has been identified as having a purchase intent for. The message communicated to the user may include one or more links to the marketplace listing and may provide additional information (e.g., price, shipping costs, size, color) about the product.

In some embodiments, the communicating of the additional message to the user may comprise determining the physical location of the user, and locating one or more local retailers (e.g., physical brick and mortar locations) that are proximal to the user and offer the product. Further, the application server 122 may access the inventory information of the one or more local retailers (e.g., hosted by one or more third party servers 114) and determine that the one or more local retailers have the product in stock. A message may then be generated by the communication module 306 that identifies the one or more local retailers with the product in stock and indicates that these one or more local retailers offer the product for sale. The generated message may then be communicated as the additional message to the at least one potential buyer.

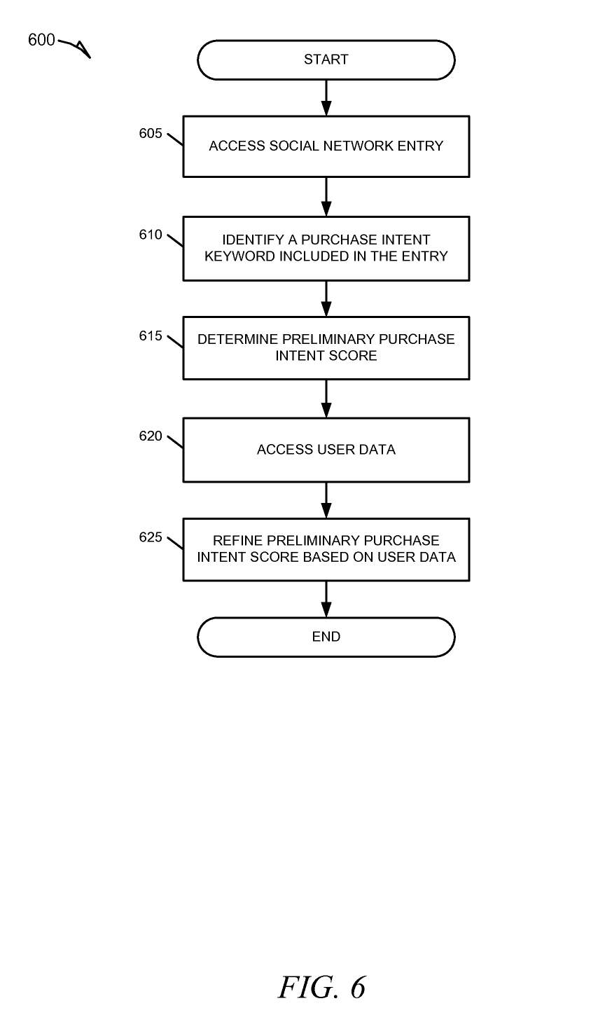

FIG. 6 is a flowchart illustrating an example method 600 for determining a purchase intent score, consistent with some embodiments. The method 600 may be embodied in computer-readable instructions for execution by one or more processors such that the steps of the method 600 may be performed in part or in whole by the application server 122. In particular, the method 600 may be carried out by the modules forming the purchase intent application 126, and accordingly, the method 600 is described below by way of example with reference thereto. However, it shall be appreciated that the method 600 may be deployed on various other hardware configurations and is not intended to be limited to the modules of the purchase intent application 126.

At operation 605, the analysis module 302 accesses a social network entry included in social data (e.g., obtained by the social media retrieval module 300). At operation 610, the analysis module 302 identifies one or more purchase intent terms (e.g., “buy,” “want,” or “need”) included in the social network entry. At operation 615, the scoring module 304 determines a preliminary purchase intent score based on the identified purchase intent term. The determination of the preliminary purchase intent score may include accessing a look-up table (e.g., stored in database 130) comprising a list of purchase intent terms and a corresponding value for each purchase intent term. In some embodiments, the value assigned to each purchase intent term may be based on the intensity of the desire to purchase expressed by the purchase intent term. For example, the term “need” expresses a greater desire to purchase an item than does “want,” and accordingly the term “need” may be provided a higher value than the term “want.”

At operation 620, the scoring module 304 accesses user data (e.g., demographic data or transaction history) corresponding to the user who generated the social network entry. At operation 625, the scoring module 304 may refine the preliminary purchase intent score based on the user data with the result being the purchase intent score of the user. For example, the scoring module 304 may increase the preliminary purchase intent score if the user data includes a transaction history of the user representing multiple purchases of products similar to the product the user has referenced in the social network entry. In another example, the scoring module 304 may increase the preliminary purchase intent score if the user data includes a browsing history of the user representing multiple page views of the product or similar products.

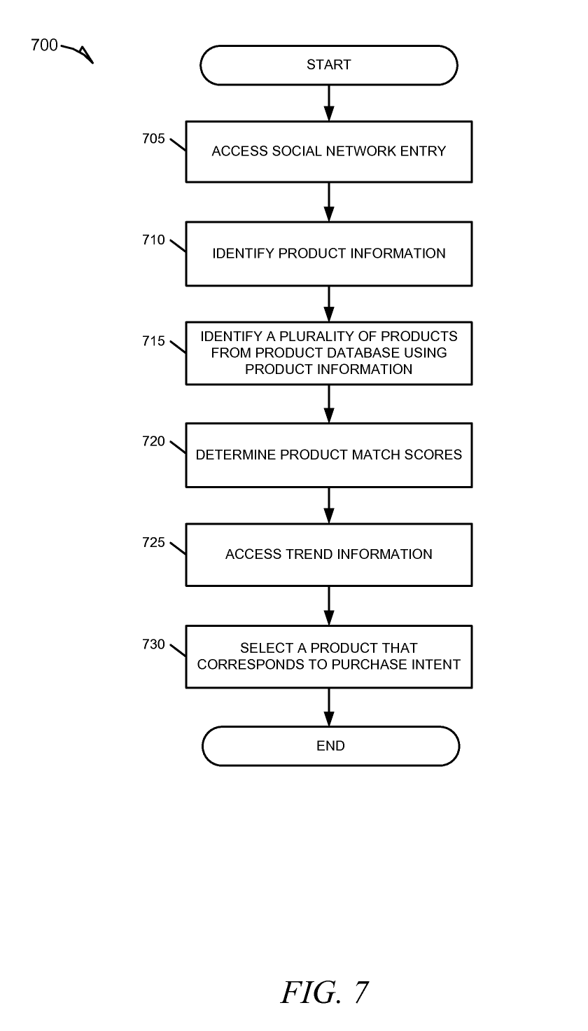

FIG. 7 is a flowchart illustrating an example method 700 for identifying a product based on product information included in a social network entry, consistent with some embodiments. The method 700 may be embodied in computer-readable instructions for execution by one or more processors such that the steps of the method 700 may be performed in part or in whole by the application server 122. In particular, the method 700 may be carried out by the modules forming the purchase intent application 126, and accordingly, the method 700 is described below by way of example with reference thereto. However, it shall be appreciated that the method 700 may be deployed on various other hardware configurations and is not intended to be limited to the modules of the purchase intent application 126.

At operation 705, the analysis module 302 accesses a social network entry included in social data (e.g., obtained by the social media retrieval module 300). The social network entry accessed by the analysis module 302 may be a social network entry from which a user's purchase intent was identified (e.g., based on the use of purchase intent terms). At operation 710, the analysis module 302 identifies product information (e.g., a product identifier) included in the social network entry. At operation 715, the analysis module 302 uses the product information to identify a plurality of products from a product database. At operation 720, the analysis module 302 determines a product match score for each product of the plurality of products identified using the product information. The product match score indicates how closely a product identified from the product database matches the product information included in the social network entry.

At operation 725, the analysis module 302 accesses trend information (e.g., stored in the database 130) for the plurality of products identified from the product database. The trend information indicates the current popularity of products based on a combination of the number of references in social media and the total number of purchases of the product (e.g., facilitated by the marketplace application 124). At operation 730, the analysis module 302 identifies a product from the plurality of products that corresponds to the purchase intent of the user expressed in the social network entry. The identification of such a product may be based on a combination of the product match score and the trend information.

In some instances, the analysis module 302 may only identify a single product from the product database using the product information. In these instances, the operations 720 and 725 may not be performed, and the single product is the product selected by the analysis module 302 at operation 730.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field-programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses that connect the hardware modules). In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment, or a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., APIs).

### Electronic Apparatus and System

Example embodiments may be implemented in digital electronic circuitry, in computer hardware, firmware, or software, or in combinations of these. Example embodiments may be implemented using a computer program product, for example, a computer program tangibly embodied in an information carrier, for example, in a machine-readable medium for execution by, or to control the operation of, data processing apparatus, for example, a programmable processor, a computer, or multiple computers.

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site, or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., an FPGA or an ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or in a combination of permanently and temporarily configured hardware may be a design choice. Below are set out hardware (e.g., machine) and software architectures that may be deployed, in various example embodiments.

### Example Machine Architecture and Machine-Readable Medium

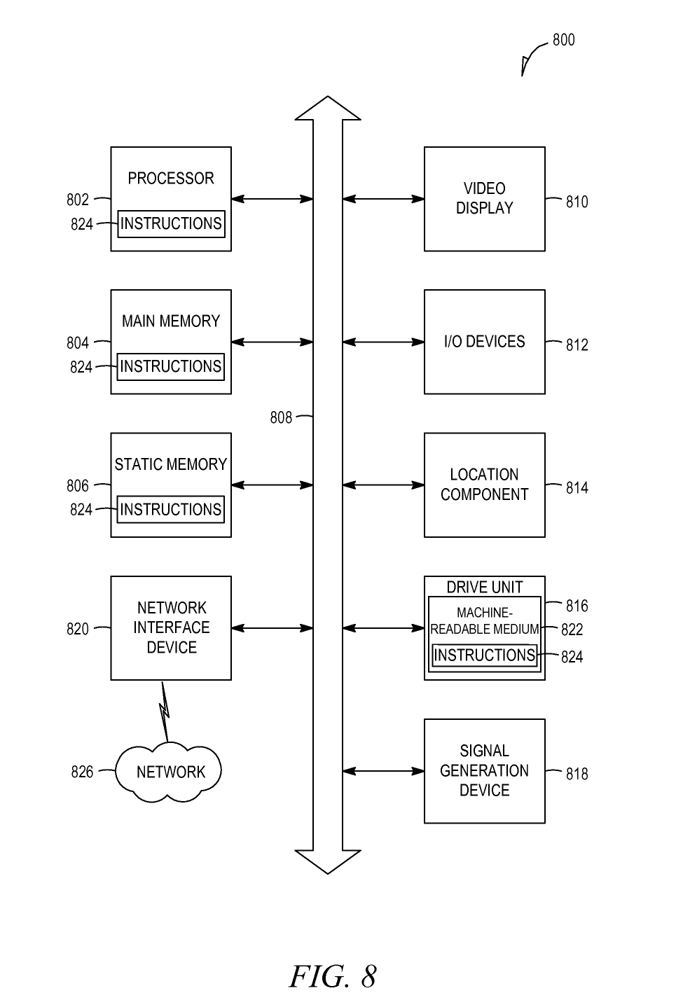

FIG. 8 is a diagrammatic representation of a machine in the example form of a computer system 800 within which a set of instructions for causing the machine to perform any one or more of the methodologies discussed herein may be executed. The computer system 800 may correspond to client device 106, third party server 114, or application server 122, consistent with some embodiments. The computer system 800 may include instructions for causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a PDA, a cellular telephone, a smart phone (e.g., iPhone®), a tablet computer, a web appliance, a handheld computer, a desktop computer, a laptop or netbook, a set-top box (STB) such as provided by cable or satellite content providers, a wearable computing device such as glasses or a wristwatch, a multimedia device embedded in an automobile, a Global Positioning System (GPS) device, a data enabled book reader, a video game system console, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 includes a processor 802 (e.g., a central processing unit (CPU), a graphics processing unit (GPU), or both), a main memory 804 and a static memory 806, which communicate with each other via a bus 808. The computer system 800 may further include a video display 810 (e.g., a liquid crystal display (LCD) or a cathode ray tube (CRT)). The computer system 800 also includes one or more input/output (I/O) devices 812, a location component 814, a drive unit 816, a signal generation device 818 (e.g., a speaker), and a network interface device 820. The I/O devices 812 may, for example, include a keyboard, a mouse, a keypad, a multi-touch surface (e.g., a touchscreen or track pad), a microphone, a camera, and the like.

The location component 814 may be used for determining a location of the computer system 800. In some embodiments, the location component 814 may correspond to a GPS transceiver that may make use of the network interface device 820 to communicate GPS signals with a GPS satellite. The location component 814 may also be configured to determine a location of the computer system 800 by using an internet protocol (IP) address lookup or by triangulating a position based on nearby mobile communications towers. The location component 814 may be further configured to store a user-defined location in main memory 804 or static memory 806. In some embodiments, a mobile location enabled application may work in conjunction with the location component 814 and the network interface device 820 to transmit the location of the computer system 800 to an application server or third party server for the purpose of identifying the location of a user operating the computer system 800.

In some embodiments, the network interface device 820 may correspond to a transceiver and antenna. The transceiver may be configured to both transmit and receive cellular network signals, wireless data signals, or other types of signals via the antenna, depending on the nature of the computer system 800.

### Machine-Readable Medium

The drive unit 816 includes a machine-readable medium 822 on which is stored one or more sets of data structures and instructions 824 (e.g., software) embodying or used by any one or more of the methodologies or functions described herein. The instructions 824 may also reside, completely or at least partially, within the main memory 804, the static memory 806, and/or within the processor 802 during execution thereof by the computer system 800, with the main memory 804, the static memory 806, and the processor 802 also constituting machine-readable media.

Consistent with some embodiments, the instructions 824 may relate to the operations of an operating system (OS). Depending on the particular type of the computer system 800, the OS may, for example, be the iOS® operating system, the Android® operating system, a BlackBerry® operating system, the Microsoft® Windows® Phone operating system, Symbian® OS, or webOS®. Further, the instructions 824 may relate to operations performed by applications (commonly known as “apps”), consistent with some embodiments. One example of such an application is a mobile browser application that displays content, such as a web page or a user interface using a browser.

While the machine-readable medium 822 is shown in an example embodiment to be a single medium, the term “machine-readable medium” may include a single medium or multiple media (e.g., a centralized or distributed database, and/or associated caches and servers) that store the one or more data structures or instructions 824. The term “machine-readable medium” shall also be taken to include any tangible medium that is capable of storing, encoding, or carrying instructions (e.g., instructions 824) for execution by the machine and that cause the machine to perform any one or more of the methodologies of the present disclosure, or that is capable of storing, encoding or carrying data structures used by or associated with such instructions. The term “machine-readable medium” shall accordingly be taken to include, but not be limited to, solid-state memories, and optical and magnetic media. Specific examples of machine-readable media include non-volatile memory, including by way of example, semiconductor memory devices (e.g., erasable programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

Furthermore, the tangible machine-readable medium is non-transitory in that it does not embody a propagating signal. However, labeling the tangible machine-readable medium “non-transitory” should not be construed to mean that the medium is incapable of movement—the medium should be considered as being transportable from one real-world location to another. Additionally, since the machine-readable medium is tangible, the medium may be considered to be a machine-readable device.

### Transmission Medium

The instructions 824 may further be transmitted or received over a network 826 using a transmission medium. The instructions 824 may be transmitted using the network interface device 820 and any one of a number of well-known transfer protocols (e.g., HTTP). Examples of communication networks include a LAN, a WAN, the Internet, mobile telephone networks, POTS networks, and wireless data networks (e.g., WiFi and WiMax networks). The term “transmission medium” shall be taken to include any intangible medium that is capable of storing, encoding, or carrying the instructions 824 for execution by the machine, and includes digital or analog communications signals or other intangible media to facilitate communication of such software.

Although the embodiments of the present inventive subject matter have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense. The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

All publications, patents, and patent documents referred to in this document are incorporated by reference herein in their entirety, as though individually incorporated by reference. In the event of inconsistent usages between this document and those documents so incorporated by reference, the usage in the incorporated references should be considered supplementary to that of this document; for irreconcilable inconsistencies, the usage in this document controls. In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim are still deemed to fall within the scope of that claim.

What is claimed:

1. A system comprising:
a processor of a machine;
a processor-implemented social media retrieval module configured to obtain social data of a plurality of users from one or more social network services, the social data including social network activity of the plurality of users;
a processor-implemented analysis module configured to identify a user from the plurality of users having an intent to purchase a product based on the social network activity; and
a processor-implemented communication module configured to communicate a message to a merchant offering the product for sale, the message informing the merchant of the intent of the user to purchase the product.

2. The system of claim 1, wherein processor-implemented analysis module is to identify the user from the plurality of users by performing operations comprising:
identifying a purchase intent term from the social network activity, the purchase intent term being indicative of the intent to purchase the product; and
identifying a product identifier referenced in conjunction with the purchase intent term.

3. The system of claim 2, further comprising a processor-implemented scoring module configured to determine a purchase intent score for the user based in part on an intensity of the purchase intent term, the purchase intent score providing a measure of the intent of the user to purchase the product.

4. The system of claim 3, wherein the purchase intent score is further based on a number of references to the product included in the social network activity of the user.

5. The system of claim 1, wherein the processor-implemented analysis module is further configured to generate market demand information based on the social data, the market demand information including a demand for the product by the plurality of users.

6. The system of claim 5, wherein the message includes the market demand information.

7. The system of claim 1, wherein the social network activity includes a plurality of social network entries made by the plurality of users, the plurality of social network entries including at least one selection from the group consisting of an activity feed post, a wall post, a status update, a tweet, a pin, a like, and a check-in.

8. The system of claim 1, wherein the processor-implemented communication module is further configured to communicate an additional message to the user, the additional message identifying at least one marketplace listing for the product.

9. A method comprising:
obtaining social data of a plurality of users from one or more social network services, the social data including social network activity of the plurality of users;
identifying a user from the plurality of users having an intent to purchase a product based on the social network activity;
determining, using a processor of a machine, a purchase intent score for the user based on the social network activity, the purchase intent score providing a measure of the intent of the user to purchase the product; and
communicating a message to a merchant offering the product for sale, the message including the purchase intent score of the user.

10. The method of claim 9, wherein the identifying the user comprises:
identifying a purchase intent term from the social network activity that is indicative of the intent to purchase the product; and
identifying product information from the social network activity referenced in conjunction with the purchase intent term.

11. The method of claim 10, wherein the determining the purchase intent score is based on at least one selection from the group consisting of purchase intent terms used in the social network activity, a particular product being referenced, other products purchased, key word searches performed, products added to an electronic shopping cart, and product listings viewed.

12. The method of claim 9, further including generating market demand information based on the social network activity, the market demand information including a demand for the product by the plurality of users.

13. The method of claim 12, wherein the message includes the market demand information.

14. The method of claim 13, wherein the message is communicated to the merchant in response to determining that the demand is above a predefined threshold.

15. The method of claim 9, wherein the message further includes one or more suggestions based on the market demand information, the one or more suggestions providing a course of action for the merchant in light of the market demand information.

16. The method of claim 9, further comprising communicating an additional message to the user, the additional message identifying at least one online marketplace listing for the product.

17. The method of claim 9, further comprising refining the purchase intent score of the user based on a transaction history of the user.

18. The method of claim 9, further comprising refining the purchase intent score of the user based on a browsing history of the user.

19. The method of claim 9, wherein the identifying the product information comprises performing image recognition on an image to identify the product from the image, the image included in a social network entry included as part of the social network activity.

20. A non-transitory machine-readable storage medium embodying instructions that, when executed by a machine, cause the machine to perform operations comprising:
determining a user with an intent to purchase a product based on an analysis of social network entries of the user;
determining a purchase intent score for the user based on the social network entries, the purchase intent score providing a measure of the intent of the user to purchase the product; and
communicating a message to a merchant offering the product for sale, the message notifying the merchant of the intent of the user to purchase the product and including the purchase intent score of the user.
